(19) United States
(12) Patent Application Publication
(10) Pub. No.: US 2026/0228252 A1
(43) Pub. Date: Aug. 6, 2026

(54) LASER MANAGEMENT SERVER AND LASER MANAGEMENT METHOD

(71) Applicant: Gigaphoton Inc., Tochigi (JP)

(72) Inventors: Yuji MINEGISHI, Oyama-shi (JP); Jacob Peter STROCK, Beaverton, OR (US)

(73) Assignee: Gigaphoton Inc., Tochigi (JP)

(21) Appl. No.: 19/045,064

(22) Filed: Feb. 4, 2025

(51) Int. Cl. G06F 16/3329; G05B 23/02; G06F 16/338

(52) U.S. Cl. CPC G06F 16/33295; G05B 23/0283; G06F 16/338

(57) ABSTRACT

A laser management server for a laser device includes a sending and receiving processor receiving a query and transmit a query response; a query input processor receiving the query, decomposing the query, and generating a first query item that requires external information and a second query item that does not require external information; an agent action processor receiving the first query item, acquiring the required external information from unstructured data and structured data of the laser device, and generating an agent response; a response output processor receiving the second query item, receiving the agent response, and generating a query item prompt related to the second query item; and a large language model processor receiving the query item prompt, and generating a query item response. The response output processor receives the query item response, configures the query response, and transmits the query response to the sending and receiving processor.

### CROSS-REFERENCE TO RELATED APPLICATIONS

The present application claims the benefit of U.S. Patent Application No. 63/565,711, filed on Mar. 15, 2024, the entire contents of which are hereby incorporated by reference.

### BACKGROUND

### 1. Technical Field

The present disclosure relates to a laser management server and a laser management method.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser device for exposure, a KrF excimer laser device for outputting laser light having a wavelength of about 248 nm and an ArF excimer laser device for outputting laser light having a wavelength of about 193 nm are used.

The KrF excimer laser device and the ArF excimer laser device each have a large spectral line width of about 350 to 400 pm in natural oscillation light. Therefore, when a projection lens is formed of a material that transmits ultraviolet rays such as KrF laser light and ArF laser light, there is a case in which chromatic aberration occurs. As a result, the resolution may decrease. Then, a spectral line width of laser light output from the gas laser device needs to be narrowed to the extent that the chromatic aberration can be ignored. For this purpose, there is a case in which a line narrowing module (LNM) including a line narrowing element (etalon, grating, and the like) is provided in a laser resonator of the gas laser device to narrow a spectral line width. In the following, a gas laser device with a narrowed spectral line width is referred to as a line narrowing gas laser device.

### LIST OF DOCUMENTS

### Patent Documents

Patent Document 1: Japanese Patent Application Publication No. 2022-19441
Patent Document 2: Japanese Patent Application Publication No. H1-216299
Patent Document 3: International Publication No. WO2020/161865

### SUMMARY

A laser management server for a laser device according to an aspect of the present disclosure includes a sending and receiving processor configured to receive a query from outside and transmit a query response that is a response to the query to outside; a query input processor configured to receive the query from the sending and receiving processor, decompose the query, and generate a first query item that requires external information and a second query item that does not require external information; an agent action processor configured to receive the first query item from the query input processor, acquire the required external information from unstructured data including a manual and a maintenance report of the laser device and structured data including operation data of the laser device, and generate an agent response that is a response to the first query item; a response output processor configured to receive the second query item from the query input processor, receive the agent response from the agent action processor, and generate a query item prompt related to the second query item; and a large language model processor configured to receive the query item prompt from the response output processor, and generate a query item response that is a response to the query item prompt. Here, the response output processor is configured to receive the query item response from the large language model processor, configure the query response based on the agent response and the query item response, and transmit the query response to the sending and receiving processor.

A laser management method for a laser device according to an aspect of the present disclosure includes a first step, to be performed by a sending and receiving processor, of receiving a query from outside; a second step, to be performed by a query input processor, of decomposing the query received from the sending and receiving processor, and generating a first query item that requires external information and a second query item that does not require external information; a third step, to be performed by an agent action processor, of receiving the first query item from the query input processor, acquiring the required external information from unstructured data including a manual and a maintenance report of the laser device and structured data including operation data of the laser device, and generating an agent response that is a response to the first query item; a fourth step, to be performed by a response output processor, of receiving the second query item from the query input processor, receiving the agent response from the agent action processor, and generating a query item prompt related to the second query item; a fifth step, to be performed by a large language model processor, of receiving the query item prompt from the response output processor, and generating a query item response that is a response to the query item prompt; a sixth step, to be performed by the response output processor, of receiving the query item response from the large language model processor, and configuring a query response based on the agent response and the query item response; and a seventh step, to be performed by the sending and receiving processor, of receiving the query response from the response output processor, and transmitting the query response to outside.

### BRIEF DESCRIPTION OF THE DRAWINGS

Embodiments of the present disclosure will be described below merely as examples with reference to the accompanying drawings.

FIG. 1 is a view showing the configuration of an exemplary laser device.

FIG. 2 is a diagram showing the configuration of a laser management system according to a comparative example.

FIG. 3 is a diagram showing the laser management system according to a first embodiment.

FIG. 4 is a diagram showing operation flow of a laser management server according to the first embodiment.

FIG. 5 is a table showing an example of query items generated from a query of a user according to the first embodiment.

FIG. 6 is a diagram showing an example of a reply content to the query of the user according to the first embodiment.

FIG. 7 is a diagram showing the laser management system according to a modification of the first embodiment.

FIG. 8 is a diagram showing operation flow of the laser management server according to the modification of the first embodiment.

FIG. 9 is a diagram showing the laser management system according to a second embodiment.

FIG. 10 is a diagram showing an example of the reply content to the query of the user according to the second embodiment.

### DESCRIPTION OF EMBODIMENTS

### Contents

1. Description of terms
2. Comparative example
   2.1 Laser device
      2.1.1 Configuration
      2.1.2 Operation
   2.2 Laser management system
      2.2.1 Configuration
      2.2.2 Operation
   2.3 Problem
3. First embodiment
   3.1 Configuration
   3.2 Operation
   3.3 Effect
4. Modification of first embodiment
   4.1 Configuration
   4.2 Operation
   4.3 Effect
5. Second embodiment
   5.1 Configuration
   5.2 Operation
   5.3 Effect
6. Others

Hereinafter, embodiments of the present disclosure will be described in detail with reference to the drawings. The embodiments described below show some examples of the present disclosure and do not limit the contents of the present disclosure. Also, all configurations and operation described in the embodiments are not necessarily essential as configurations and operation of the present disclosure. Here, the same components are denoted by the same reference numeral, and duplicate description thereof is omitted.

### 1. DESCRIPTION OF TERMS

Terms used in the present specification are defined as follows. “Standard software” is application software that performs at least one task of management, monitoring, and analysis of a particular device based on predefined functions and display specifications.

A “web application” is application software that is available on the Internet using a web browser. The web application can be used on various terminals such as a personal computer, a smartphone, a tablet, and the like, as long as it is connected to the Internet, without installing application software.

A “standard operation screen” is a standard user interface (UI) of application software designed in advance.

An “interactive operation screen” is an operation screen in which a user issues questions and commands in a natural language, and application software responds to the questions and the commands from the user.

“Unstructured data” is data that has neither regularity nor continuity, and is in a format that is difficult to manage in a normal database or table. The unstructured data is, for example, a text document, an image, an audio file, or the like.

“Operation data” is information generated through operation of a laser device.

A “specialized information processing processor” is a chat agent having a high level of expertise for a specific field. Unlike a general chat agent, the specialized information processing processor can accurately respond to dialogs related to terms and concepts in a field of specialization.

A “query” is an inquiry or an instruction that the entire system receives from a user. The query is an instruction character string configured by a natural language that designates information to be acquired and a provision format of the information, or designates operation to be performed by the laser device. The query is, for example, “Report an operation diagnosis of the laser 65400011 in a standard format.”

A “query response” is a result configured by a natural language returned by the system in response to a specific query. The query response includes not only a character string, but also a graph, an image, or the like depending on the content.

A “large language model processor (LLM)” performs processing by an artificial intelligence (AI) model trained using a large amount of text data in natural language processing. The large language model processor understands and performs complex language tasks.

A “prompt” is an instruction or a question in a natural language text transmitted to the LLM. The prompt causes the LLM to understand what to respond to or what task to perform.

A “query input processor (QIP)” performs a process of analyzing a user's request (query) and replacing the query with an appropriate input prompt for the LLM.

A “response output processor (ROP)” performs a process of configuring a content to be returned as an answer response of the LLM into a format and a content according to the content designated by a user.

An “agent action processor (AAP)” analyzes an output of the LLM, acquires information required to form an appropriate response from an external information source, and performs a process of assembling an appropriate response that matches a user's query.

### 2. COMPARATIVE EXAMPLE

### 2.1 Laser Device

### 2.1.1 Configuration

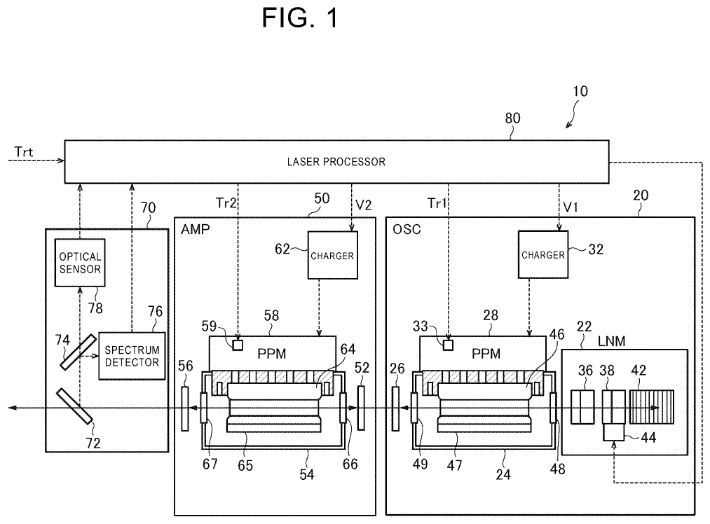

FIG. 1 is a view schematically showing the configuration of an exemplary laser device 10. The laser device 10 is a discharge-excitation-type gas laser device, and includes an oscillator (OSC) 20, an amplifier (AMP) 50, a monitor module 70, and a laser processor 80. The processor of the present disclosure is a processing device including a storage device in which a control program is stored and a CPU which performs the control program. The processor is specifically configured or programmed to perform various processes.

The OSC 20 includes a line narrowing module (LNM) 22, a chamber 24, an output coupler (OC) 26, a pulse power module (PPM) 28, and a charger 32.

The LNM 22 includes prisms 36, 38, a grating 42, and a rotation stage 44 that rotates the prism 38. The LNM 22 changes the incident angle on the grating 42 by rotating the prism 38 so that the center wavelength of pulse laser light is controlled.

The chamber 24 includes a pair of discharge electrodes 46, 47 and two windows 48, 49 through which laser light is transmitted. An excimer laser gas is introduced into the chamber 24. The excimer laser gas includes, for example, a rare gas (an Ar gas or a Kr gas), a halogen gas (an F₂ gas), and a buffer gas (an Ne gas).

The OC 26 is a partial reflection mirror that reflects a part of the pulse laser light and transmits the other part.

The LNM 22 and the OC 26 configure an optical resonator together, and the chamber 24 is arranged on the optical path of the optical resonator.

The AMP 50 includes a rear mirror (RM) 52, a chamber 54, an output coupler (OC) 56, a pulse power module (PPM) 58, and a charger 62.

The RM 52 is a partial reflection mirror that reflects a part of the pulse laser light and transmits the other part. The reflectance of the RM 52 may be between 80% and 90%.

The chamber 54 includes a pair of discharge electrodes 64, 65 and two windows 66, 67 through which the laser light is transmitted. The excimer laser gas is introduced into the chamber 54.

The OC 56 is a partial reflection mirror that reflects a part of the pulse laser light and transmits the other part. The reflectance of the OC 56 may be between 10% and 30%.

The RM 52 and the OC 56 configure an optical resonator together, and the chamber 54 is arranged on the optical path of the optical resonator. The optical resonator may be a Fabry-Perot optical resonator.

The monitor module 70 includes beam splitters 72, 74, a spectrum detector 76 that measures the wavelength and the spectral line width of the pulse laser light, and an optical sensor 78 that detects the pulse energy of the pulse laser light. The spectrum detector 76 may be an etalon spectrometer. The optical sensor 78 may be a photodiode.

### 2.1.2 Operation

The laser processor 80 receives a target center wavelength λt and a target pulse energy Et from an external apparatus such as an exposure apparatus (not shown). Then, the laser processor 80 sets a charge voltage V1 of the charger 32 and a charge voltage V2 of the charger 62 such that the pulse laser light having the target pulse energy Et can be obtained.

A first charging capacitor (not shown) in the PPM 28 is charged with the charge voltage V1. A second charging capacitor (not shown) in the PPM 58 is charged with the charge voltage V2.

Upon receiving a light emission trigger Trt from the external apparatus such as the exposure apparatus, the laser processor 80 transmits a light emission trigger Tr1 to the switch 33 in the PPM 28. When the switch 33 is operated, charges charged in the first charging capacitor are converted into high voltage pulses in the PPM 28 in accordance with the charge voltage V1 and applied between the discharge electrodes 46, 47 in the chamber 24.

As a result, discharge occurs between the discharge electrodes 46, 47 in the chamber 24, and the laser gas is excited. Then, the light line-narrowed by the optical resonator configured of the OC 26 and the LNM 22 to an ultraviolet wavelength of 380 nm to 150 nm is output from the OSC 20 as seed light. The wavelength of the seed light may be an oscillation wavelength of the ArF excimer laser or an oscillation wavelength of the KrF excimer laser.

Further, upon receiving the light emission trigger Trt, the laser processor 80 transmits a light emission trigger Tr2 to the switch 59 of the PPM 58 so that discharge occurs between the discharge electrodes 64, 65 when the seed light output from the OSC 20 enters the discharge space of the chamber 54 of the AMP 50.

When the switch 59 is operated, charges charged in the second charging capacitor are converted into high voltage pulses in the PPM 58 in accordance with the charge voltage V2 and applied between the discharge electrodes 64, 65 in the chamber 54.

As a result, discharge occurs between the discharge electrodes 64, 65 in the chamber 54, and the laser gas is excited. At this timing, the seed light output from the OSC 20 is transmitted through the RM 52 and enters the discharge space in the chamber 54. The entering seed light is amplified by the optical resonator configured of the RM 52 and the OC 56, and is output from the AMP 50.

The pulse laser light output from the AMP 50 enters the monitor module 70. A part of the pulse laser light entering the monitor module 70 is reflected by the beam splitter 72, and a part of the reflected pulse laser light is further reflected by the beam splitter 74 and enters the spectrum detector 76. The pulse laser light transmitted through the beam splitter 74 enters the optical sensor 78.

The spectrum detector 76 measures the center wavelength of the pulse laser light. The optical sensor 78 measures the pulse energy of the pulse laser light.

The laser processor 80 may control the rotation stage 44 in the LNM 22 so that the center wavelength measured by the spectrum detector 76 becomes the target center wavelength λt. The rotation stage 44 may include a piezoelectric element.

The laser processor 80 may control the charge voltage V2 output from the charger 62 so that the pulse energy measured by the optical sensor 78 becomes the target pulse energy Et.

### 2.2 Laser Management System

### 2.2.1 Configuration

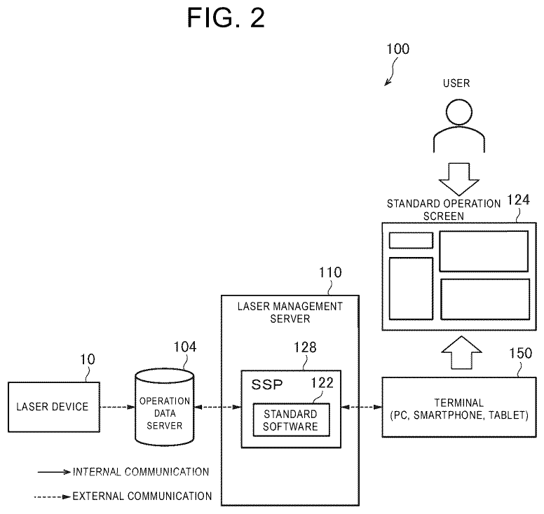

FIG. 2 is a diagram showing the configuration of a laser management system 100 according to a comparative example. The comparative example of the present disclosure is an example recognized by the applicant as known only by the applicant, and is not a publicly known example admitted by the applicant. The laser management system 100 performs at least one of management, monitoring, and analysis of the laser device 10.

The laser management system 100 includes the laser device 10, an operation data server 104, a laser management server 110, and a terminal 150.

The operation data server 104 is a data server in which operation data of the laser device 10 is stored.

The terminal 150 is, for example, a personal computer, a smartphone, a tablet, or the like.

The laser management server 110 includes a standard software processor (SSP) 128 in which standard software 122 is stored.

The SSP 128 acquires operation data of the laser device 10 from the operation data server 104 via a network.

The standard software 122 is provided in a form of a web application to be operated via the network.

A standard operation screen 124 of the standard software 122 is displayed on the terminal 150 so as to be operable by a user.

### 2.2.2 Operation

The laser device 10 transmits the operation data to the operation data server 104, and the operation data server 104 accumulates the operation data.

The laser management server 110 receives a request of viewing predetermined information or the like from the user through the standard operation screen 124.

The standard software 122 of the laser management server 110 performs analysis and the like of a predetermined laser device 10 using the accumulated operation data. The standard software 122 provides the user with at least one of the functions of management, monitoring, and analysis of the predetermined laser device 10.

The standard software 122 of the laser management server 110 displays requested information and the like on the standard operation screen 124.

The user views the information on the standard operation screen 124.

Different standard software 122 or a different standard operation screen 124 is provided to different users such as a field service engineer (FSE), a device owner, and a research-and-development engineer according to their respective applications.

### 2.3 Problem

In a semiconductor manufacturing site, the standard software 122 is used for management and monitoring of operation of the laser device 10 and maintenance of the laser device 10. The standard software 122 can only perform display or operation based on predetermined operation specifications.

In recent semiconductor manufacturing sites, needs for analysis, monitoring, and retrieval of data using application software are becoming more sophisticated as manufacturing processes become more complicated and diversified. However, it is difficult to satisfy the needs of various users only by operation or screens determined in advance by the standard software 122.

Further, data that can be handled by application software is currently limited to only structured data whose values are clear, for example, device parameters and sensor data. Further, a handwritten report document, manual, image, and the like created by a person also includes information effective for sophisticated data analysis. However, since such information is unstructured data having neither regularity nor continuity, it is difficult to handle them as analysis data.

### 3. FIRST EMBODIMENT

### 3.1 Configuration

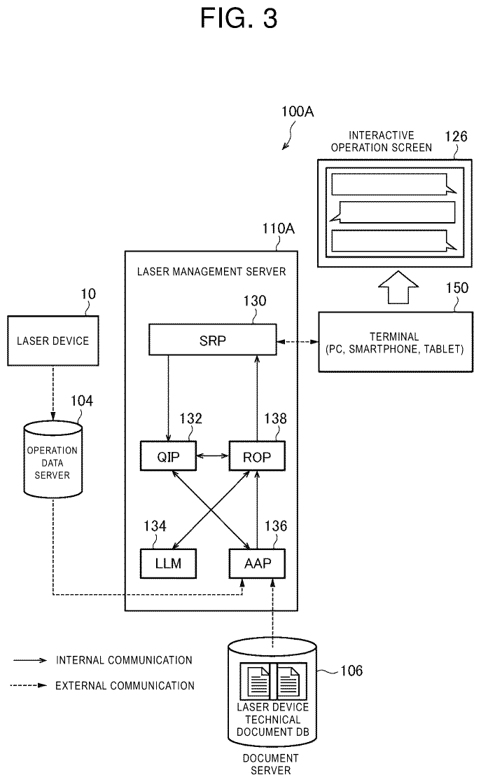

FIG. 3 is a diagram showing a laser management system 100A according to a first embodiment. The configuration shown in FIG. 3 will be described in terms of differences from the configuration shown in FIG. 2.

The laser management system 100A differs from the laser management system 100 in the configuration in the laser management server 110A, in that a document server 106 is connected to the laser management server 110A, and that a screen actually handled by the user through the terminal 150 is changed from the standard operation screen 124 to an interactive operation screen 126.

The laser management server 110A includes a sending and receiving processor (SRP) 130, a query input processor (QIP) 132, a large language model processor (LLM) 134, an agent action processor (AAP) 136, and a response output processor (ROP) 138.

The SRP 130, the QIP 132, the LLM 134, the AAP 136, and the ROP 138 may be application software or hardware such as a CPU. Respective pieces of application software may be collectively implemented as a single processor.

The user's input and output to and from the laser management system 100A is performed on the interactive operation screen 126 on the terminal 150 through the SRP 130.

The document server 106 includes a laser device technical document database (DB) that stores unstructured data such as technical documents such as manuals and maintenance reports of the laser device 10.

At least one of the operation data server 104 and the document server 106 may be implemented in the laser management server 110A.

### 3.2 Operation

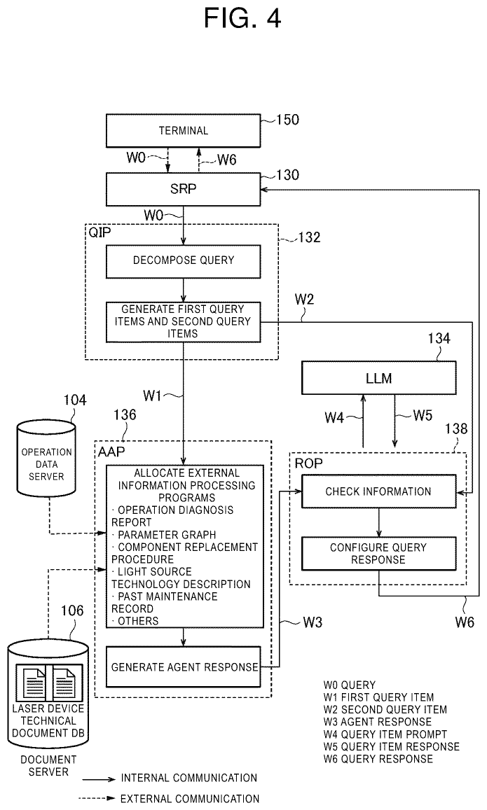

FIG. 4 is a diagram showing operation flow of the laser management server 110A according to the first embodiment.
[Step 1] The SRP 130 receives a query W0 from the terminal 150. Step 1 is an example of the “first step” in the present disclosure. A method for the user to input the query W0 to the terminal 150 is not limited to key input with a physical keyboard or an application software keyboard, but may be voice input. Further, for example, the query W0 may be input via communication of at least one of email, short message, and voicemail.
[Step 2] The QIP 132 decomposes the query W0 received from the SRP 130, and generates first query items W1 that require external information and second query items W2 that do not require external information. Step 2 is an example of the “second step” in the present disclosure.

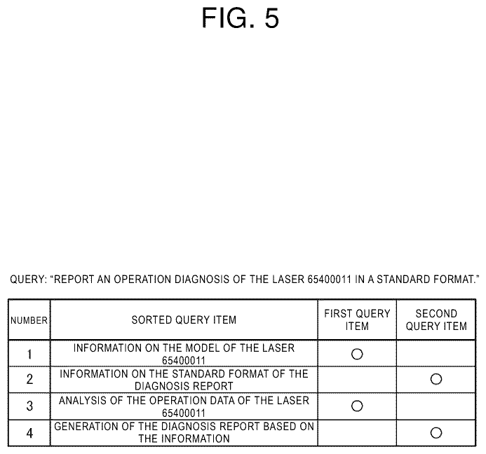

FIG. 5 is a table showing an example of the first query items W1 and the second query items W2 generated from the query W0. FIG. 5 shows a generation example of the query items when the query W0 received from the QIP 132 is “Report an operation diagnosis of the laser 65400011 in a standard format.” Here, “laser 65400011” is a name for identifying a type (model) of the laser.

In this case, the QIP 132 decomposes the received query W0 into four query items. The query item of item number 1 is “Information on the model of the laser 65400011”, the query item of item number 2 is “Information on the standard format of the diagnosis report”, the query item of item number 3 is “Analysis of the operation data of the laser 65400011”, and the query item of item number 4 is “Generation of the diagnosis report based on the information”.

Among these four query items, the query items of item numbers 1 and 3 are classified into the first query items W1 because it is difficult to obtain an appropriate answer by the LLM 134 alone and external information is required to obtain an appropriate answer. The query items of item numbers 2 and 4 do not require external information for answering, and are classified into the second query items W2.

Here, the external information refers to information existing in the operation data server 104 or the document server 106. The criterion for determining whether or not the query item requires external information is, for example, whether or not a response with high accuracy can be generated by the LLM 134 alone. For query items classified into the first query items W1, it is difficult to generate a response with high accuracy by the LLM 134 alone. For query items classified into the second query items W2, a response with high accuracy can be generated by the LLM 134 alone. A response with high accuracy refers to a response that is based on facts and has less false recognition and error.

Here, depending on the content of the query W0 received from the SRP 130, only either the first query items W1 or the second query items W2 may be generated.
[Step 3] The QIP 132 transmits the second query items W2 to the ROP 138.
[Step 4] The QIP 132 transmits the first query items W1 to the AAP 136. Further, the first query items W1 may also be transmitted to the ROP 138 for use in checking information.
[Step 5] The AAP 136 allocates a corresponding external information processing program for each of the first query items W1. The external information processing program acquires required information from the outside (the operation data server 104 or the document server 106), analyzes the information, and summarizes the result.

For example, for the first query item W1 of item number 3 of FIG. 5, the AAP 136 acquires, from the operation data server 104, an application voltage (HV) between the discharge electrodes 46, 47 in the chamber 24 of the OSC 20 of the laser 65400011, a gas pressure in the chamber 24 of the OSC 20, and a total number of shots of the device, analyzes the data, and summarizes the result.

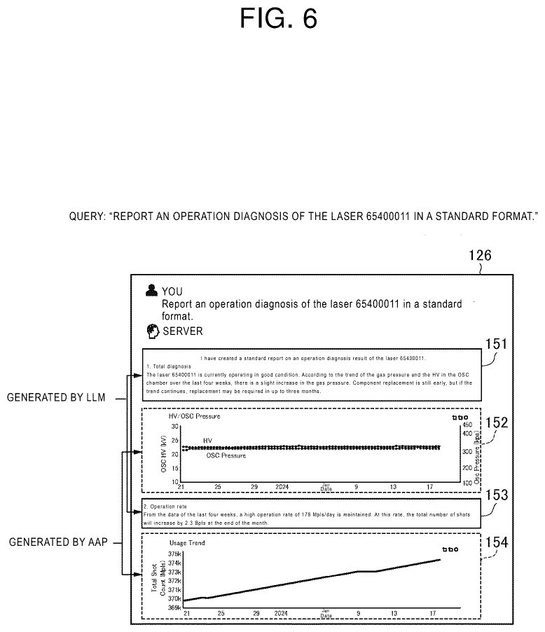

The information acquired by the external information processing program may include, for example, an operation diagnosis report, a parameter graph, a component replacement procedure, a light source technology description, a past maintenance record, and the like.
[Step 6] The AAP 136 performs all of the allocated external information processing programs. Then, the AAP 136 performs an external information configuring process to summarize all of the information related to the execution result, and generates an agent response W3 that is a response to the first query items W1. Steps 5 and 6 are an example of the “third step” in the present disclosure. Here, later-described AAP generation results 152, 154 of FIG. 6 are examples of the agent response W3. Thus, the agent response W3 is not limited to text information, and may include a graph, a table, and the like.
[Step 7] The AAP 136 transmits the agent response W3 to the ROP 138.
[Step 8] The ROP 138 receives the second query items W2 from the QIP 132.
[Step 9] The ROP 138 may receive the agent response W3 from the AAP 136 and check whether or not required information is included.
[Step 10] The ROP 138 generates a query item prompt W4 related to a response to the second query items W2. Steps 8 to 10 are an example of the “fourth step” in the present disclosure. For example, the query item prompt W4 of the second query item W2 of item number 2 shown in FIG. 5 is “Tell me the standard format of the diagnosis report.” Further, the query item prompt W4 of the second query item W2 of item number 4 shown in FIG. 5 includes the agent response W3 required for the response and a prompt “Generate a report for this agent response.”
[Step 11] The LLM 134 receives the query item prompt W4 from the ROP 138 and generates a query item response W5 that is a response to the query item prompt W4. Step 11 is an example of the “fifth step” in the present disclosure.

For example, the query item response W5 to the query item prompt W4 of the second query item W2 of item number 2 shown in FIG. 5 is “Report the total diagnosis result and the individual performance based on the operation data of the device.” Further, the query item response W5 to the query item prompt W4 of the second query item W2 of item number 4 shown in FIG. 5 is, for example, as follows.

### “1. Total Diagnosis

The laser 65400011 is currently operating in good condition.

According to the trend of the gas pressure and the HV in the OSC chamber over the last four weeks, there is a slight increase in the gas pressure.

Component replacement is still early, but if the trend continues, replacement may be required in up to three months.”
[Step 12] The ROP 138 receives the query item response W5 from the LLM 134. Then, the ROP 138 configures a query response W6 based on the agent response W3 and the query item response W5. Step 12 is an example of the “sixth step” in the present disclosure.
[Step 13] The ROP 138 transmits the configured query response W6 to the SRP 130.
[Step 14] The SRP 130 transmits the query response W6 to the terminal 150. Step 14 is an example of the “seventh step” in the present disclosure.
[Step 15] The query response W6 is displayed on the interactive operation screen 126 on the terminal 150.

FIG. 6 is a diagram showing an example of the query response W6 displayed on the terminal 150. FIG. 6 shows a display example of the query response W6 when the query W0 is “Report operation diagnosis of the laser 65400011 in a standard format.” In response to the query W0, the laser management server 110A returns the query response W6 as shown in FIG. 6 to the user.

In FIG. 6, the query response W6 displayed on the interactive operation screen 126 includes LLM generation results 151, 153 and the AAP generation results 152, 154. The LLM generation results 151, 153 are results generated by the LLM 134. The AAP generation results 152, 154 are results generated by the AAP 136. The AAP generation results 152, 154 may include a graph, a table, and the like. Here, creation of a graph of operation data may be performed by the AAP 136 or the LLM 134.

In the interactive operation screen 126, the AAP generation result 152 may be displayed immediately below the LLM generation result 151. In the case of FIG. 6, since the AAP generation result 152 is information related to the LLM generation result 151 and the AAP generation result 154 is information related to the LLM generation result 153, it is preferable that the query response W6 is configured in a layout in which, for example, the LLM generation result 151, the AAP generation result 152, the LLM generation result 153, and the AAP generation result 154 are alternately arranged so that related information is displayed on the screen in an organized manner to be user-friendly.

The ROP 138 combines the LLM generation results 151, 153 generated by the LLM 134 with the AAP generation results 152, 154 received from the AAP 136 to generate the query response W6 in which screen display as shown in FIG. 6 is realized.

When the SRP 130 receives a query W0 again in response to the query response W6 displayed on the interactive operation screen 126, the laser management server 110A performs the processes from steps 2 to 15 again. Steps 1 to 15 are an example of the “laser management method” in the present disclosure.

### 3.3 Effect

Since the laser management system 100A according to the first embodiment includes a language-processable LLM 134 in the laser management server 110A, there is no limitation on the format of the query W0 or the display method of the query response W6.

The first query items W1 that require external information are acquired by the AAP 136. The acquired external information is transmitted to the LLM 134 via the ROP 138. Therefore, the LLM 134 can also utilize information specialized for the laser device 10 such as unstructured data such as technical documents of the laser device 10 that has not been learned and structured data such as operation data of the laser device 10.

Since the AAP 136 acquires external information each time, the LLM 134 can generate the query item response W5 including latest external information.

According to the laser management server 110A of the first embodiment, the query response W6 can be generated in response to the query W0 from various users, such as an FSE, a device owner, and a research-and-development engineer. Accordingly, it is possible to provide the laser management server 110A that satisfies the needs of various users.

The first query items W1 are used by the AAP 136 to acquire external information, analyze the external information, and create the agent response W3. The first query items W1 that require external information are then transmitted to the LLM 134 in the form of the agent response W3. Accordingly, as compared with a case in which all of the external information is transmitted to the LLM 134, the amount of information received by the LLM 134 is reduced in the laser management server 110A according to the first embodiment, so that the reception capacity of the LLM 134 for prompts can be suppressed.

Further, since the laser management server 110A according to the first embodiment does not require various standard operation screens 124, it is possible to reduce the time and cost required for a UI development process as compared with the laser management server 110 according to the comparative example.

### 4. MODIFICATION OF FIRST EMBODIMENT

### 4.1 Configuration

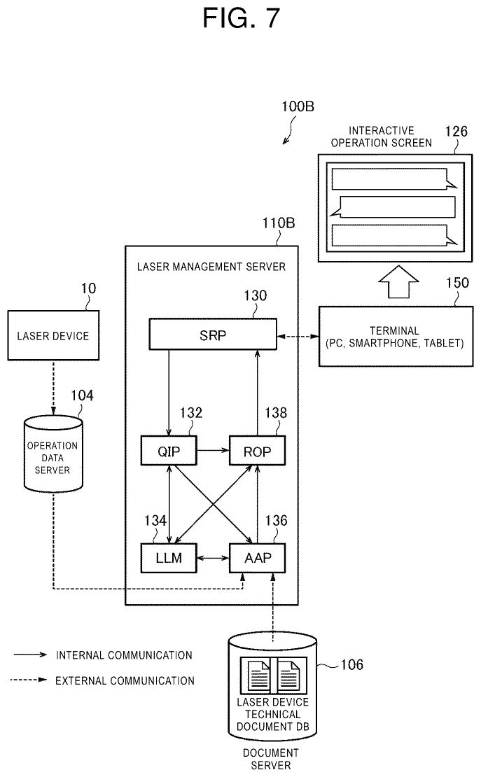

FIG. 7 is a diagram showing a laser management system 100B according to a modification of the first embodiment. The configuration shown in FIG. 7 will be described in terms of differences from the configuration shown in FIG. 3. The laser management server 110B shown in FIG. 7 differs from the laser management server 110A shown in FIG. 3 in that communication is performed between the QIP 132 and the LLM 134, and between the AAP 136 and the LLM 134. Other configurations may be similar to those shown in FIG. 3.

### 4.2 Operation

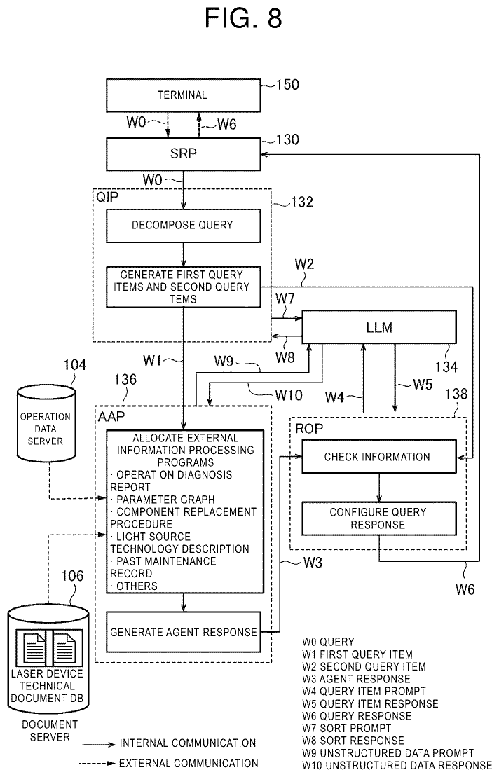

FIG. 8 is a diagram showing operation flow of the laser management server 110B according to the modification of the first embodiment. The operation flow shown in FIG. 8 will be described in terms of differences from that shown in FIG. 4.

The QIP 132 of the laser management server 110B may generate a sort prompt W7 when performing language processing in the generation of the first query items W1 and the second query items W2. The sort prompt W7 is, for example, “Decompose the query into items.”

The LLM 134 may receive the sort prompt W7 from the QIP 132 and generate a sort response W8 that is a response to the sort prompt W7. The sort response W8 is, for example, query items divided into items as shown in FIG. 5.

The QIP 132 may receive the sort response W8 from the LLM 134.

The AAP 136 may generate an unstructured data prompt W9 when acquiring unstructured data and creating the agent response W3. The unstructured data prompt W9 includes, for example, a manual of the laser device 10 and a prompt of “Tell me where the replacement method of the chamber is described.”

The LLM 134 may receive the unstructured data prompt W9 from the AAP 136 and generate an unstructured data response W10 that is a response to the unstructured data prompt W9. The unstructured data response W10 is, for example, “The replacement method of the chamber is described in line BB of page AA to line DD of page CC.”

The AAP 136 may receive the unstructured data response W10 from the LLM 134. The AAP 136 analyzes the unstructured data response W10 received from the LLM 134 and generates the agent response W3. For example, when the unstructured data response W10 of “The replacement method of the chamber is described in line BB of page AA to line DD of page CC.” is received, the AAP 136 allocates an appropriate external information processing program and generates the agent response W3 from the allocation result. Other operation may be similar to that in FIG. 4.

### 4.3 Effect

According to the laser management server 110B, effects similar to those of the laser management server 110A can be obtained. In addition, the language processing function is further improved in both of the QIP 132 and the AAP 136 in the laser management server 110B.

### 5. SECOND EMBODIMENT

### 5.1 Configuration

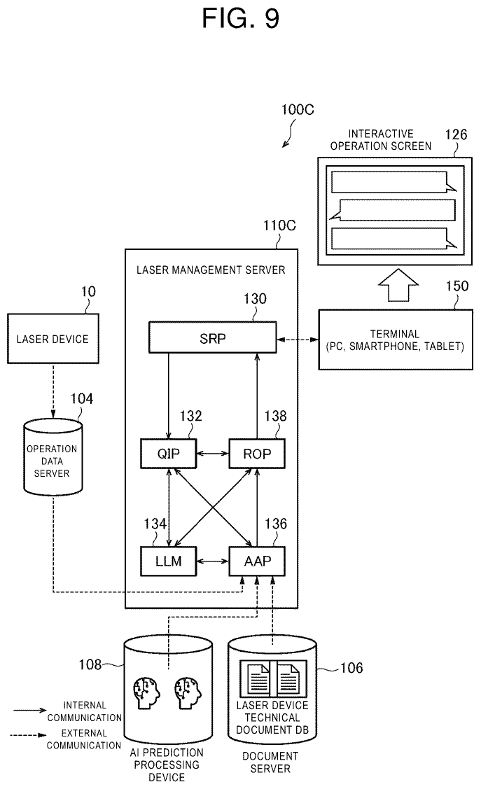

FIG. 9 is a diagram showing a laser management system 100C according to a second embodiment. The configuration shown in FIG. 9 will be described in terms of differences from the configuration shown in FIG. 7.

The laser management system 100C differs from the laser management system 100B in that an AI prediction processing device 108 is connected to a laser management server 110C.

The AI prediction processing device 108 includes a lifetime prediction model for predicting the lifetime of consumables of the laser device 10 and a laser performance prediction model for predicting the future laser performance of the laser device 10. The lifetime prediction model and the laser performance prediction model are learned AI models trained by machine learning to perform a target task. The lifetime prediction model and the laser performance prediction model are implemented in the AI prediction processing device 108. Other configurations may be similar to those shown in FIG. 7.

### 5.2 Operation

The lifetime prediction model may be, for example, a learned model created by a machine learning method described in Patent Document 3. The machine learning method described in Patent Document 3 is a machine learning method for creating a learning model for predicting the lifetime of a consumable of the laser device 10 and includes: acquiring first lifetime-related information including data of a lifetime-related parameter of the consumable recorded corresponding to the number of oscillation pulses during different time periods from the start of the use of the consumable to the replacement thereof; dividing the first lifetime-related information into a plurality of levels representing the deterioration degree of the consumable according to the number of oscillation pulses and creating training data in which the first lifetime-related information is associated with the level representing the deterioration degree; creating a learning model for predicting the deterioration degree of the consumable from the data of the lifetime-related parameter by performing machine learning using the training data; and storing the created learning model.

Here, the learning model is, for example, a neural network model, and is, in substance, a program that causes the computer to perform a process of predicting the deterioration degree of the consumable of the laser device 10.

The AI prediction processing device 108 can predict the lifetime of each of the consumables scheduled to be replaced by using a corresponding lifetime prediction model for the consumable scheduled to be replaced in the laser device 10 based on the lifetime-related information of the consumable. The prediction result of the lifetime prediction model is transmitted from the AAP 136 to the ROP 138 as the agent response W3.

The laser performance prediction model is a learned model capable of predicting transition of the laser performance of the laser device 10 in the future according to the number of pulses or the date and time in an arbitrary component replacement scenario. The prediction result of the laser performance prediction model is transmitted from the AAP 136 to the ROP 138 as the agent response W3.

In the ROP 138, the query response W6 is configured based on the agent response W3 and the query item response W5, and the query response W6 is displayed on the interactive operation screen 126 on the terminal 150.

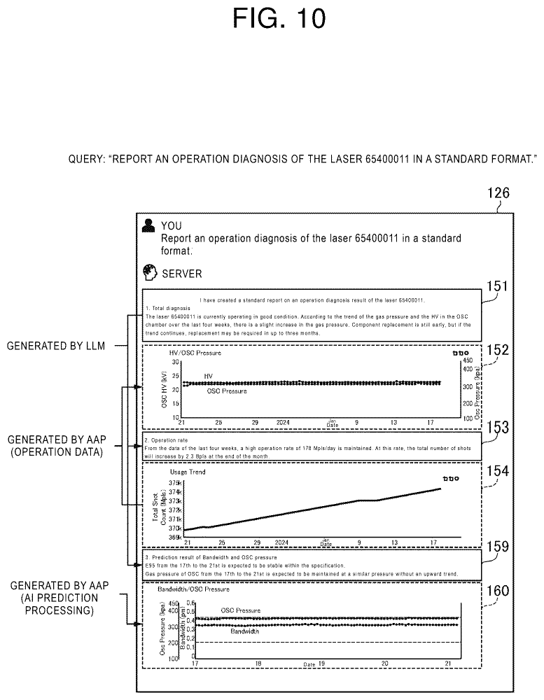

FIG. 10 is a diagram showing an example of the query response W6 displayed on the terminal 150 in the second embodiment. FIG. 10 is a display example of a user reply content as the query response W6 when the query W0 is “Report an operation diagnosis of the laser 65400011 in a standard format.” FIG. 10 will be described in terms of differences from FIG. 6.

In FIG. 10, as compared with FIG. 6, prediction results of the bandwidth (spectral line width) of a spectrum of pulse laser light and the gas pressure in the chamber 24 of the OSC 20 are added. That is, in FIG. 10, the interactive operation screen 126 includes an LLM generation result 159 and an AAP generation result 160. The LLM generation result 159 is a result generated by the LLM 134. The AAP generation result 160 is a result obtained by the AAP 136 using the laser performance prediction model of the AI prediction processing device 108. The AAP generation result 160 may include a graph, a table, and the like. Here, each of the bandwidth of the spectrum of the pulse laser light and the gas pressure in the chamber 24 of the OSC 20 is an example of the “performance of the laser device” in the present disclosure.

### 5.3 Effect

According to the laser management system 100C of the second embodiment, similar effects to those of the first embodiment can be obtained. Further, in the laser management system 100C, since the agent response W3 can be generated by using the prediction result of the lifetime of each of the consumables scheduled to be replaced and the information of the prediction result of the laser performance of the laser device 10 obtained from the AI prediction processing device 108, the quality of the query response W6 to the query W0 related to the prediction is improved.

### 6. OTHERS

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious to those skilled in the art that the embodiments of the present disclosure would be appropriately combined.

The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more”. Further, “at least one of A, B, and C” should be interpreted to mean any of A, B, C, A+B, A+C, B+C, and A+B+C as well as to include combinations of any thereof and any other than A, B, and C.

What is claimed is:

1. A laser management server for a laser device, comprising:
a sending and receiving processor configured to receive a query from outside and transmit a query response that is a response to the query to outside;
a query input processor configured to receive the query from the sending and receiving processor, decompose the query, and generate a first query item that requires external information and a second query item that does not require external information;
an agent action processor configured to receive the first query item from the query input processor, acquire the required external information from unstructured data including a manual and a maintenance report of the laser device and structured data including operation data of the laser device, and generate an agent response that is a response to the first query item;
a response output processor configured to receive the second query item from the query input processor, receive the agent response from the agent action processor, and generate a query item prompt related to the second query item; and
a large language model processor configured to receive the query item prompt from the response output processor, and generate a query item response that is a response to the query item prompt,
the response output processor being configured to receive the query item response from the large language model processor, configure the query response based on the agent response and the query item response, and transmit the query response to the sending and receiving processor.

2. The laser management server according to claim 1,
wherein the query item prompt includes the agent response.

3. The laser management server according to claim 1,
wherein the agent action processor acquires the structured data including a prediction result of lifetime of a consumable of the laser device by a lifetime prediction model.

4. The laser management server according to claim 1,
wherein the agent action processor acquires the structured data including a prediction result of performance of the laser device by a laser performance prediction model.

5. The laser management server according to claim 1,
wherein the query input processor generates a sort prompt for decomposing the query when performing language processing in the generation of the first query item and the second query item,
the large language model processor receives the sort prompt from the query input processor, and generates a sort response that is a response to the sort prompt, and
the query input processor receives the sort response from the large language model processor.

6. The laser management server according to claim 1,
wherein the agent action processor generates an unstructured data prompt when acquiring the unstructured data and creating the agent response,
the large language model processor receives the unstructured data prompt from the agent action processor, and generates an unstructured data response that is a response to the unstructured data prompt, and
the agent action processor receives the unstructured data response from the large language model processor.

7. The laser management server according to claim 6,
wherein the unstructured data prompt includes the unstructured data.

8. The laser management server according to claim 1,
wherein the response output processor combines information generated by the large language model processor and the agent response received from the agent action processor to configure the query response.

9. The laser management server according to claim 1,
wherein the sending and receiving processor receives the query from a terminal connected via a network, and transmits the query response to the terminal.

10. The laser management server according to claim 9,
wherein the query is received through an interactive operation screen on the terminal, and the query response is displayed on the interactive operation screen on the terminal.

11. A laser management method for a laser device, comprising:
a first step, to be performed by a sending and receiving processor, of receiving a query from outside;
a second step, to be performed by a query input processor, of decomposing the query received from the sending and receiving processor, and generating a first query item that requires external information and a second query item that does not require external information;
a third step, to be performed by an agent action processor, of receiving the first query item from the query input processor, acquiring the required external information from unstructured data including a manual and a maintenance report of the laser device and structured data including operation data of the laser device, and generating an agent response that is a response to the first query item;
a fourth step, to be performed by a response output processor, of receiving the second query item from the query input processor, receiving the agent response from the agent action processor, and generating a query item prompt related to the second query item;
a fifth step, to be performed by a large language model processor, of receiving the query item prompt from the response output processor, and generating a query item response that is a response to the query item prompt;
a sixth step, to be performed by the response output processor, of receiving the query item response from the large language model processor, and configuring a query response based on the agent response and the query item response; and
a seventh step, to be performed by the sending and receiving processor, of receiving the query response from the response output processor, and transmitting the query response to outside.

12. The laser management method according to claim 11,
wherein the third step includes acquiring, to be performed by the agent action processor, the structured data including a prediction result of lifetime of a consumable of the laser device by a lifetime prediction model.

13. The laser management method according to claim 11,
wherein the third step includes acquiring, to be performed by the agent action processor, the structured data including a prediction result of laser performance of the laser device by a laser performance prediction model.

14. The laser management method according to claim 11,
wherein the third step includes generating a sort prompt for decomposing the query into the first query item and the second query item when performing language processing in the generation of the first query item and the second query item; receiving, to be performed by the large language model processor, the sort prompt from the query input processor; generating, to be performed by the large language model processor, a sort response that is a response to the sort prompt; and receiving, to be performed by the query input processor, the sort response from the large language model processor.

15. The laser management method according to claim 11,
wherein the agent action processor generates an unstructured data prompt when acquiring the unstructured data and creating the agent response,
the large language model processor receives the unstructured data prompt from the agent action processor, and generates an unstructured data response that is a response to the unstructured data prompt, and
the agent action processor receives the unstructured data response from the large language model processor.

16. The laser management method according to claim 15,
wherein the unstructured data prompt includes the unstructured data.

17. The laser management method according to claim 11,
wherein the query item prompt includes the agent response.

18. The laser management method according to claim 11,
wherein the sixth step includes combining, to be performed by the response output processor, information generated by the large language model processor and the agent response received from the agent action processor to configure the query response.

19. The laser management method according to claim 11,
wherein the first step includes receiving, to be performed by the sending and receiving processor, the query from a terminal connected via a network, and
the seventh step includes transmitting the query response to the terminal.

20. The laser management method according to claim 19,
wherein the query is received through an interactive operation screen on the terminal, and the query response is displayed on the interactive operation screen on the terminal.
